(19) United States
(12) Patent Application Publication
(10) Pub. No.: US 2025/0274349 A1
(43) Pub. Date: Aug. 28, 2025

(54) SYSTEM AND METHOD FOR SPECTRUM REFARMING OF A CELL SITE ON A TELECOMMUNICATIONS NETWORK

(71) Applicant: T-Mobile USA, Inc., Bellevue, WA (US)

(72) Inventors: Omar Hassan, Kirkland, WA (US); Gunjan Nimbavikar, Sammamish, WA (US)

(21) Appl. No.: 18/590,694

(22) Filed: Feb. 28, 2024

(51) Int. Cl. H04L 41/14; H04W 24/02; H04W 28/16

(52) U.S. Cl. CPC H04L 41/145; H04W 24/02; H04W 28/16

(57) ABSTRACT

The system obtains device information of a wireless device connected to a cell site. The system obtains spectrum information of the cell site. The system simulates spectrum refarming of the cell site based on the device information and the spectrum information. The system estimates an effect on performance or user experience of the wireless device based on the simulation of the spectrum refarming of the cell site, which includes a potential disruption to a service of the telecommunications network. The system performs a process to determine whether the wireless device is capable of supporting the service without disruption after the spectrum refarming of the cell site. The system determines that an upgrade related to the wireless device is required to support the service without disruption. The system causes an output on a computing device of an indication of the effect caused by the spectrum refarming of the cell site.

### BACKGROUND

Network planning and design is an iterative process, usually encompassing topological design, network synthesis, and network realization, and is aimed at ensuring that spectrum refarming a telecommunications network or service meets the needs of subscribers and operators. Spectrum refarming refers to the repurposing of spectrum bands to more efficient technologies and/or new services. For instance, a service provider may be using 900 MHz to provide 2G services. However, with the ever-growing demand for data services, the service provider might want to free some of this 900 MHz spectrum for LTE services. The process by which this is done is known as spectrum refarming. Spectrum refarming is defined as a process governing the repurposing of frequency bands that have historically been allocated for 2G mobile services for a new generation of mobile technologies.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates a system that can simulate a spectrum refarming of a cell site.

FIG. 3 is a block diagram that illustrates a geographic location with cell sites classified for spectrum refarming.

FIG. 4 is a flowchart that illustrates a process which performs a simulation of a spectrum refarming of a cell site.

FIG. 5 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a Network tool (“the tool”) for forecasting the effect a proposed network change plan such as a proposed spectrum refarming plan for a telecommunications cell site will have on a wireless device in range of the cell site on a telecommunications network. For example, the tool aids in determining whether a spectrum refarming plan is advisable or what the spectrum refarming plan should be. Spectrum refarming is the process of updating a telecommunications cell site to allocate more resources to newer wireless network generations. For example, a spectrum refarming plan can allocate resources from 2G and/or 3G networks to LTE and/or 5G networks. The spectrum refarming process can cause a wireless device to become obsolete. For example, the wireless device may become obsolete due to an inability to connect to the telecommunications cell site, or the wireless device may no longer have access to the telecommunications network services a user is subscribed to. During spectrum refarming, estimates are made of the expected traffic intensity and traffic load that a network must support. Accordingly, spectrum refarming tools include software and hardware components to evaluate existing networks' performance and plan updates to cell sites. However, the current tools are complex and unreliable.

The tool obtains wireless device information from a wireless device in range of and connected to the cell site where the network change or spectrum refarming will occur. For example, the wireless device information can include device capabilities, device usage patterns, and/or device location data. Wireless device capabilities can include the type of mobile broadband modem contained in the wireless device or wireless network generations to which the wireless device can connect. The tool obtains the cell site spectrum information. For example, the telecommunications cell site spectrum information can include data relating to the amount of resources partitioned to different wireless networks. The tool can obtain a network change plan or spectrum refarming plan for the cell site. For example, the spectrum refarming plan can include the proposed changes to the amount of resources partitioned to each type of wireless network.

The tool can estimate an effect on the wireless device's performance or the user's experience of the wireless device. For example, an affected wireless device can be a wireless device in range of the telecommunications cell site that, due to the network change or spectrum refarming, experiences a disruption to a telecommunications network service. The tool uses the wireless device information and telecommunications cell site spectrum information to estimate how the wireless device is affected. The tool can determine when the affected wireless devices can comply with the spectrum refarming. For example, the tool can use artificial intelligence (AI) to make the determination. For example, a wireless device can comply with the spectrum refarming of the cell site by updating a device setting. The device setting, for example, can be a setting that allows the wireless device to connect to a newer wireless network generation. The tool can display, as an output, the effect the spectrum refarming of the cell site has on the wireless device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

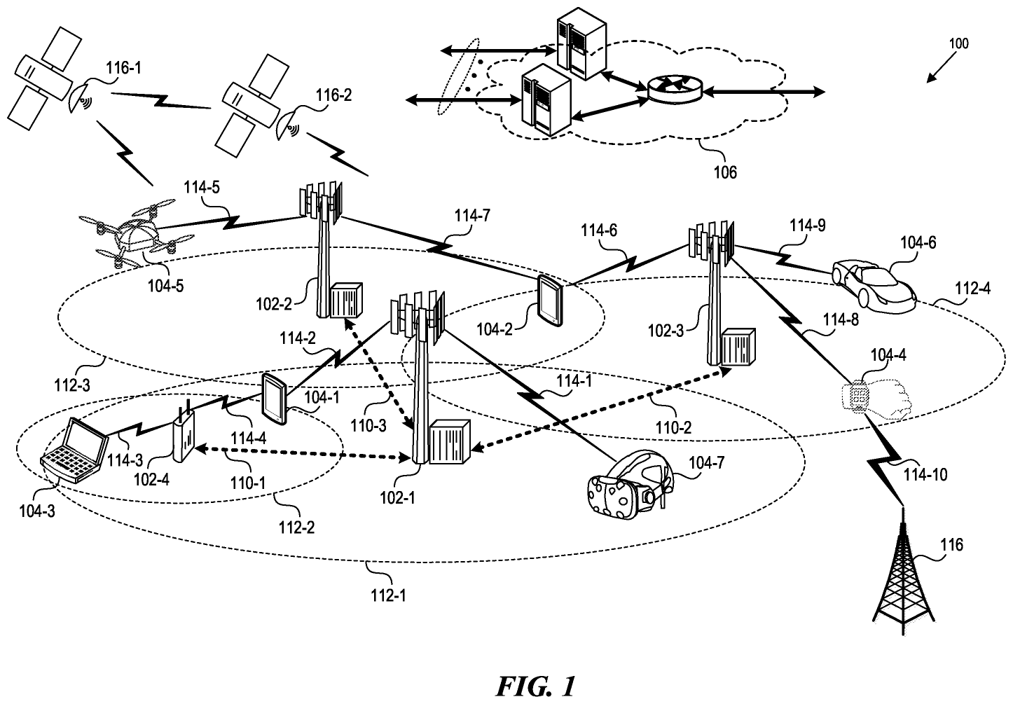

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Spectrum Refarming Tool

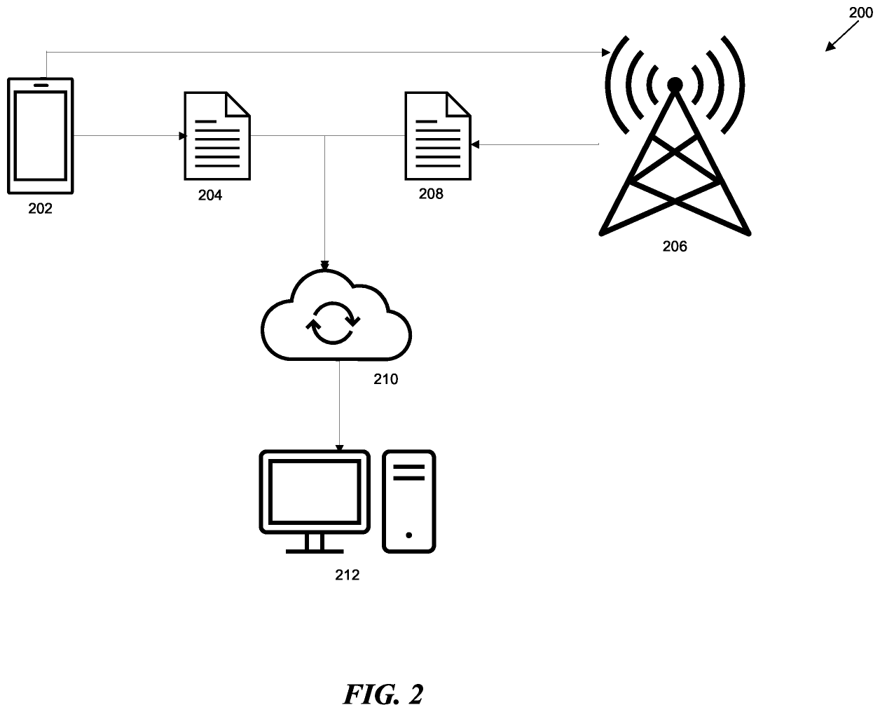

FIG. 2 is a block diagram that illustrates an example system 200 capable of simulating a spectrum refarming of cell site 206. For example, a spectrum refarming of cell site 206 may occur due to a need to update cell site 206 so that cell site 206 can provide newer generation wireless networks to subscribers. Wireless device 202 can connect to cell site 206. Cell site 206 can provide the services wireless device 202 subscribes to, such as talk, text, or data services. To simulate the spectrum refarming of cell site 206, device information 204 from wireless device 202 can be received by simulation tool 210. The device information 204 can include information relating to the device capabilities and the device usage patterns. Simulation tool 210 can receive spectrum information 208 from cell site 206. The spectrum information 208 can include data related to resources partitioned for different types of wireless networks or legacy wireless networks.

Simulation tool 210 simulates the spectrum refarming based on the device information 204 and the spectrum information 208. The simulation estimates the effect of the spectrum refarming on the performance of wireless device 202. For example, the simulation can estimate whether wireless device 202 will experience decreased performance or whether the user experience of wireless device 202 will be negatively impacted. Additionally, the effect can include a disruption to the services of wireless device 202, causing wireless device 202 to no longer be capable of accessing the services wireless device 202 subscribes to. Simulation tool 210, for example, can use AI to perform the simulation and determine the effect on wireless device 202.

Simulation tool 210 performs a process to determine whether wireless device 202 can support the service without disruption after the spectrum refarming of cell site 206 is complete. For example, wireless device 202 can support the service after the spectrum refarming when nothing needs to be done to wireless device 202, or a network setting can be updated on wireless device 202, which allows it to comply with the spectrum refarming. For example, a network setting that allows wireless device 202 to prioritize newer generation wireless services over legacy network generations can be updated to allow for compliance with the spectrum refarming.

Simulation tool 210 can output the simulation results onto computing device 212. For example, the output can indicate the effect caused by the spectrum refarming of cell site 206. The output can also provide a prompt to perform an action related to upgrading wireless device 202. For example, an upgrade to wireless device 202 can be an update to a network setting or an indication that wireless device 202 cannot comply and a different wireless device is needed to continue accessing the services provided by cell site 206.

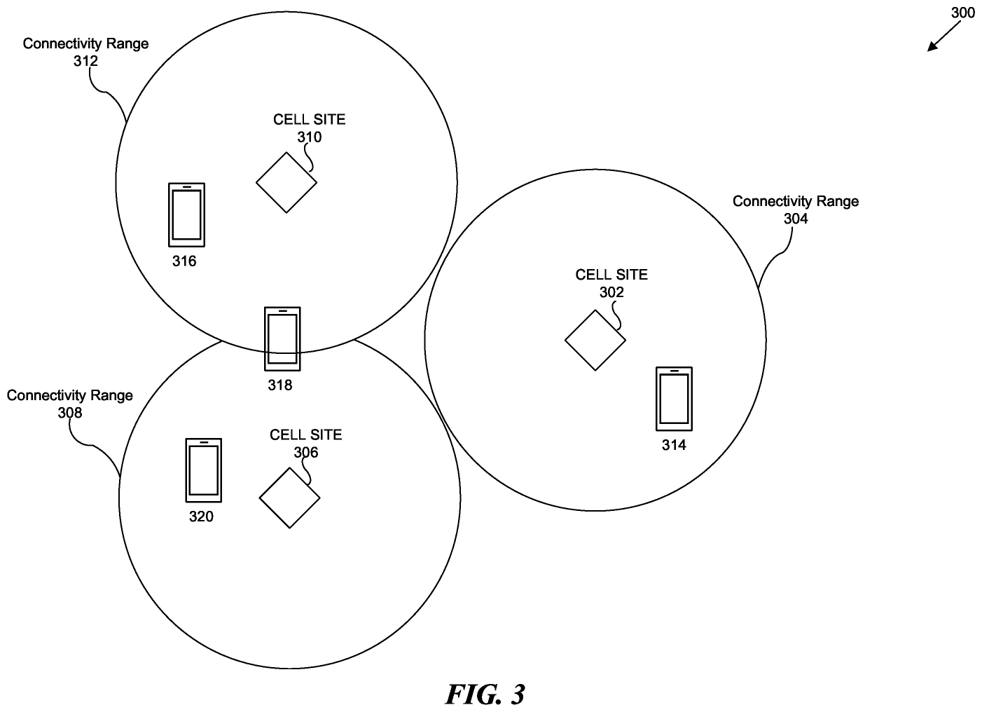

FIG. 3 is a block diagram that illustrates a geographic location 300 that contains cell site 302, cell site 306, and cell site 310, which are classified for a network change such as a spectrum refarming. Geographic location 300 can contain multiple cell sites. The cell sites can have an overlapping connectivity range or have no overlap in their connectivity range.

Cell site 302 can have a connectivity range 304, which does not overlap with connectivity range 308 of cell site 306 or connectivity range 312 of cell site 310. A network change to cell site 302 can affect the services of wireless device 314 because wireless device 314 is inside connectivity range 304 of cell site 302. A network change to cell site 302 would not affect the services of wireless device 316, wireless device 318, or wireless device 320 because the wireless devices are outside connectivity range 304 of cell site 302.

Cell site 306 can have a connectivity range 308, which does not overlap with connectivity range 304 of cell site 302 but does overlap with connectivity range 312 of cell site 310. A network change to cell site 306 can affect the services of wireless device 320 and wireless device 318 as both devices are within connectivity range 308. The network change to cell site 306 would not affect the services of wireless device 316 or wireless device 314 as both wireless devices are outside connectivity range 308 of cell site 306.

Cell site 310 can have a connectivity range 312, which does not overlap with connectivity range 304 of cell site 302 but does overlap with connectivity range 308 of cell site 306. A network change to cell site 310 can affect the services of wireless device 316 and wireless device 318. For example, a network change to cell site 306 and cell site 310 can affect the services of wireless device 318 because wireless device 318 is located in both connectivity range 308 and connectivity range 312. The network change to cell site 310 would not affect the services of wireless device 314 or wireless device 320 as both wireless devices are outside connectivity range 312 of cell site 310.

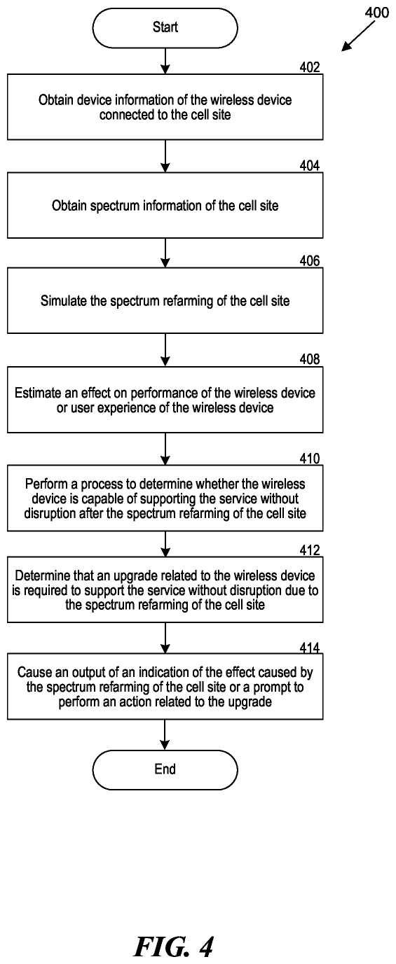

FIG. 4 is a flowchart that illustrates process 400 performed by a tool for simulation of a spectrum refarming of a cell site. In one example, the tool can be embodied in a computer system, the system including at least one hardware processor and at least one non-transitory memory storing instructions, which, when executed by the at least one hardware processor, cause the system to perform the process 400.

At 402, the system can obtain device information of the wireless device connected to the cell site. In one example, the device information includes device capabilities and device usage patterns. At 404, the system can obtain spectrum information of the cell site. In one example, the spectrum information of the cell site includes data relating to resources partitioned for different services of the telecommunications network. In one example, the system can receive a request to predict an effect on the wireless device caused by the spectrum refarming of the cell site, where the cell site contains a threshold percentage of resources partitioned to a legacy wireless network.

At 406, the system can simulate the spectrum refarming of the cell site based on the device information and the spectrum information. In one example, the system can simulate a spectrum refarming of multiple cell sites. The multiple cell sites have an overlapping connectivity range. The simulation includes the location of the overlapping connectivity range. The system can determine a degree to which the spectrum refarming of the multiple cell sites affects the wireless device. The system can modify the spectrum refarming of the multiple cell sites to reduce a percentage of wireless devices affected by the spectrum refarming of the cell site including the wireless device.

At 408, the system can estimate an effect on performance of the wireless device or user experience of the wireless device based on the simulation of the spectrum refarming of the cell site. In one example, the effect includes a potential disruption to a service of the telecommunications network subscribed to by the wireless device. In one example, the wireless device information includes location information of the wireless device. The system can determine a degree to which the spectrum refarming of the cell site affects the wireless device based on the wireless device location data. The determination includes a time period when the wireless device is located in a connectivity range of the cell site. At 410, the system can perform a process to determine whether the wireless device is capable of supporting the service without disruption after the spectrum refarming of the cell site.

At 412, the system can determine, based on the process, that an upgrade related to the wireless device is required to support the service without disruption due to the spectrum refarming of the cell site. In one example, the system can determine that the wireless device is incapable of complying with the spectrum refarming to support the service. The system can generate a notification indicating that the wireless device will experience a disruption to the service caused by the spectrum refarming of the cell site. The notification indicates that the wireless device needs to be replaced to support the service after the spectrum refarming of the cell site, and the output includes the notification presented on the wireless device to prompt replacement of the wireless device. In another example, the system can determine that the wireless device is capable of complying with the spectrum refarming to support the service. The system can generate a notification indicating that an update to a network setting on the wireless device is needed for the wireless device to support the service after the spectrum refarming of the cell site. The notification includes instructions for updating to the network setting, and the output includes the notification presented on the wireless device to prompt the update of the network setting.

At 414, the system can cause an output, on a computing device, of an indication of the effect caused by the spectrum refarming of the cell site or a prompt to perform an action related to the upgrade. In one example, the system can modify the spectrum refarming of the cell site to estimate a reduction in a percentage of wireless devices affected by the spectrum refarming of the cell site. The modified spectrum refarming of the cell site increases the percentage of wireless devices capable of supporting the service without a disruption. The system can cause an output, on a computing device, that provides an indication that the services remain available to the wireless device and that the modified spectrum refarming of the cell site negates the need for a replacement of the wireless device. In another example, the output includes an indication of one or more risk levels to multiple wireless devices subscribed to the telecommunications network. A high risk level indicates that a first threshold percentage of the wireless devices are unable to comply with the spectrum refarming of the cell site and that a different form of spectrum refarming of the cell site should be enacted. A moderate risk level indicates that a second threshold percentage of wireless devices are unable to comply with the spectrum refarming of the cell site and that the different form of spectrum refarming of the cell site should be considered. A low risk level indicates that a third threshold percentage of wireless devices are unable to comply with the spectrum refarming of the cell site and that the spectrum refarming of the cell site should be enacted.

### Computer System

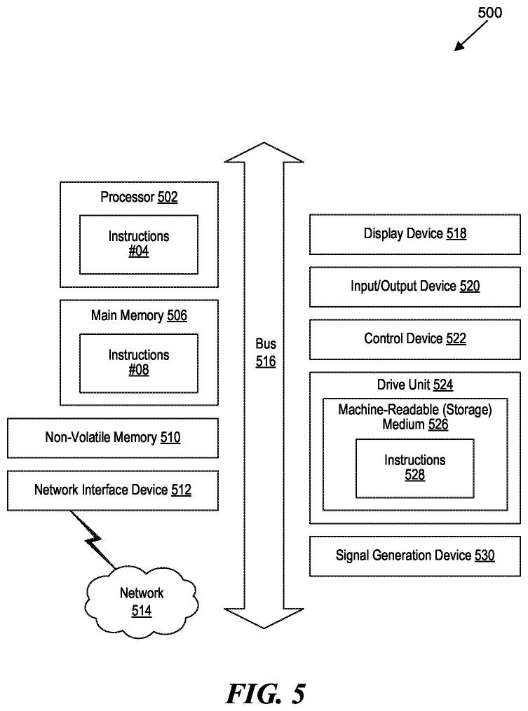

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A computer-implemented method for forecasting an effect on a wireless device caused by spectrum refarming of a cell site of a telecommunications network, the method comprising:
obtaining device information of the wireless device connected to the cell site,
wherein the device information includes device capabilities and device usage patterns;
obtaining spectrum information of the cell site,
wherein the spectrum information includes data relating to resources partitioned for different services of the telecommunications network;
simulating the spectrum refarming of the cell site based on the device information and the spectrum information;
estimating an effect on performance of the wireless device or user experience of the wireless device based on the simulation of the spectrum refarming of the cell site,
wherein the effect includes a potential disruption to a service of the telecommunications network subscribed to by the wireless device;
performing a process to determine whether the wireless device is capable of supporting the service without disruption after the spectrum refarming of the cell site;
determining, based on the process, that an upgrade related to the wireless device is required to support the service without disruption after the spectrum refarming of the cell site; and
causing an output, on a computing device, of an indication of the effect caused by the spectrum refarming of the cell site or a prompt to perform an action related to the upgrade.

2. The method of claim 1, wherein performing the process to determine whether the wireless device is capable of supporting the service without disruption after the spectrum refarming of the cell site comprises:
determining that the wireless device is incapable of complying with the spectrum refarming to support the service; and
generating a notification indicating that the wireless device will experience the disruption to the service caused by the spectrum refarming of the cell site,
wherein the notification indicates that the wireless device needs to be replaced to support the service after the spectrum refarming of the cell site, and
wherein the output includes the notification presented on the wireless device to prompt replacement of the wireless device.

3. The method of claim 1, wherein performing the process to determine whether the wireless device is capable of supporting the service without disruption after the spectrum refarming of the cell site comprises:
determining that the wireless device is capable of complying with the spectrum refarming to support the service; and
generating a notification indicating that an update to a network setting on the wireless device is needed for the wireless device to support the service after the spectrum refarming of the cell site,
wherein the notification includes instructions for updating to the network setting, and
wherein the output includes the notification presented on the wireless device to prompt the update of the network setting.

4. The method of claim 1, wherein the device information includes location information of the wireless device, the method further comprising:
determining a degree to which the spectrum refarming of the cell site affects the wireless device based on the location information of the wireless device,
wherein the determination includes a time period when the wireless device is located in a connectivity range of the cell site.

5. The method of claim 1, further comprising:
modifying the spectrum refarming of the cell site to estimate a reduction in a percentage of wireless devices affected by the spectrum refarming of the cell site,
wherein the modified spectrum refarming of the cell site increases the percentage of wireless devices capable of supporting the service without the disruption; and
causing the output, on the computing device, that provides an indication that the services remain available to the wireless device and that the modified spectrum refarming of the cell site negates a need for a replacement of the wireless device.

6. The method of claim 1, further comprising:
simulating a spectrum refarming of multiple cell sites,
wherein the multiple cell sites have an overlapping connectivity range, and
wherein the simulation includes a location of the overlapping connectivity range;
determining a degree to which the spectrum refarming of the multiple cell sites affects the wireless device; and
modifying the spectrum refarming of the multiple cell sites to reduce a percentage of wireless devices affected by the spectrum refarming of the cell site including the wireless device.

7. The method of claim 1, further comprising, prior to simulating the spectrum refarming of the cell site:
receiving a request to predict an effect on the wireless device caused by the spectrum refarming of the cell site,
wherein the cell site contains a threshold percentage of resources partitioned to a legacy wireless network.

8. The method of claim 1, wherein the output includes an indication of one or more risk levels to multiple wireless devices subscribed to the telecommunications network, the one or more risk levels comprising:
a high risk level indicating that a first threshold percentage of the multiple wireless devices are unable to comply with the spectrum refarming of the cell site and that a different form of spectrum refarming of the cell site should be enacted;
a moderate risk level indicating that a second threshold percentage of the multiple wireless devices are unable to comply with the spectrum refarming of the cell site and that the different form of spectrum refarming of the cell site should be considered; and
a low risk level indicating that a third threshold percentage of the multiple wireless devices are unable to comply with the spectrum refarming of the cell site and that the spectrum refarming of the cell site should be enacted.

9. A system comprising:
at least one hardware processor; and
at least one non-transitory memory storing instructions, which, when executed by the at least one hardware processor, cause the system to:
obtain device information of a wireless device connected to a cell site,
wherein the device information includes device capabilities and device usage patterns;
obtain spectrum information of the cell site,
wherein the spectrum information includes data relating to resources partitioned for different types of wireless networks of a telecommunications network;
simulate a spectrum refarming of the cell site based on the device information and the spectrum information;
estimate an effect on performance of the wireless device or user experience of the wireless device based on the simulation of the spectrum refarming of the cell site,
wherein the effect includes a potential disruption to a service of the telecommunications network subscribed to by the wireless device;
perform a process to determine whether the wireless device is capable of supporting the service without disruption after the spectrum refarming of the cell site;
determine, based on the process, that an upgrade related to the wireless device is required to support the service without disruption after the spectrum refarming of the cell site; and
cause an output, on a computing device, of an indication of the effect caused by the spectrum refarming of the cell site or a prompt to perform an action related to the upgrade.

10. The system of claim 9, wherein performing the process to determine whether the wireless device is capable of supporting the service without disruption after the spectrum refarming of the cell site, further causes the system to:
determine that the wireless device is incapable of complying with the spectrum refarming to support the service; and
generate a notification indicating that the wireless device will experience a disruption to the service caused by the spectrum refarming of the cell site,
wherein the notification indicates that the wireless device needs to be replaced to support the service after the spectrum refarming of a cell site, and
wherein the output includes the notification presented on the wireless device to prompt replacement of the wireless device.

11. The system of claim 9, wherein the device information includes location information of the wireless device, the instructions further cause the system to:
determine a degree to which the spectrum refarming of the cell site affects the wireless device based on the location information of the wireless device,
wherein the determination includes a time period when the wireless device is located in a connectivity range of the cell site.

12. The system of claim 9, the instructions further cause the system to:
modify the spectrum refarming of the cell site to estimate a reduction in a percentage of wireless devices affected by the spectrum refarming of the cell site,
wherein the modified spectrum refarming of the cell site increases the percentage of the wireless devices capable of supporting the service without a disruption; and
cause an output, on a computing device, that provides an indication that the services remain available to the wireless device and that the modified spectrum refarming of the cell site negates a need for a replacement of the wireless device.

13. The system of claim 9, the instructions further cause the system to:
simulate a spectrum refarming of multiple cell sites,
wherein the multiple cell sites have an overlapping connectivity range, and
wherein the simulation includes a location of the overlapping connectivity range;
determine a degree to which the spectrum refarming of the multiple cell sites affects the wireless device; and
modify the spectrum refarming of the multiple cell sites to reduce a percentage of wireless devices affected by the spectrum refarming of the cell site including the wireless device.

14. The system of claim 9, wherein performing the process to determine whether the wireless device is capable of supporting the service without disruption after the spectrum refarming of the cell site, further causes the system to:
determine that the wireless device is capable of complying with the spectrum refarming to support the service; and
generate a notification indicating that an update to a network setting on the wireless device is needed for the wireless device to support the service after the spectrum refarming of a cell site,
wherein the notification includes instructions for updating to the network setting, and
wherein the output includes the notification presented on the wireless device to prompt the update of the network setting.

15. A non-transitory, computer-readable storage medium comprising instructions recorded thereon, wherein the instructions, when executed by at least one data processor of a system, cause the system to:
obtain device information of a wireless device connected to a cell site,
wherein the device information includes device capabilities and device usage patterns;
obtain spectrum information of the cell site,
wherein the spectrum information includes data relating to resources partitioned for different types of wireless networks of a telecommunications network;
simulate a spectrum refarming of the cell site based on the device information and the spectrum information;
estimate an effect on performance of the wireless device or user experience of the wireless device based on the simulation of the spectrum refarming of the cell site,
wherein the effect includes a potential disruption to a service of the telecommunications network subscribed to by the wireless device;
perform a process to determine whether the wireless device is capable of supporting the service without disruption after the spectrum refarming of the cell site;
determine, based on the process, that an upgrade related to the wireless device is required to support the service without disruption after the spectrum refarming of the cell site; and
cause an output, on a computing device, of an indication of the effect caused by the spectrum refarming of the cell site or a prompt to perform an action related to the upgrade.

16. The computer-readable storage medium of claim 15, wherein performing the process to determine whether the wireless device is capable of supporting the service without disruption after the spectrum refarming of the cell site, the instructions further cause the system to:
determine that the wireless device is incapable of complying with the spectrum refarming to support the service; and
generate a notification indicating that the wireless device will experience a disruption to the service caused by the spectrum refarming of the cell site,
wherein the notification indicates that the wireless device needs to be replaced to support the service after the spectrum refarming of a cell site, and
wherein the output includes the notification presented on the wireless device to prompt replacement of the wireless device.

17. The computer-readable storage medium of claim 15, wherein the device information includes location information of the wireless device, the instructions further cause the system to:
determine a degree to which the spectrum refarming of the cell site affects the wireless device based on location information of the wireless device,
wherein the determination includes a time period when the wireless device is located in a connectivity range of the cell site.

18. The computer-readable storage medium of claim 15, the instructions further cause the system to:
modify the spectrum refarming of the cell site to estimate a reduction in a percentage of wireless devices affected by the spectrum refarming of the cell site,
wherein the modified spectrum refarming of the cell site increases the percentage of wireless devices capable of supporting the service without a disruption; and
cause an output, on a computing device, that provides an indication that the services remain available to the wireless device and that the modified spectrum refarming of the cell site negates a need for replacement of the wireless device.

19. The computer-readable storage medium of claim 15, the instructions further cause the system to:
simulate a spectrum refarming of multiple cell sites,
wherein the multiple cell sites have an overlapping connectivity range, and
wherein the simulation includes a location of the overlapping connectivity range;
determine a degree to which the spectrum refarming of the multiple cell sites affects the wireless device; and
modify the spectrum refarming of the multiple cell sites to reduce a percentage of wireless devices affected by the spectrum refarming of the cell site including the wireless device.

20. The computer-readable storage medium of claim 15, wherein the output includes an indication of one or more risk levels to multiple wireless devices subscribed to the telecommunications network, the one or more risk levels comprising:
a high risk level indicating that a first threshold percentage of the multiple wireless devices are unable to comply with the spectrum refarming of the cell site and that a different form of spectrum refarming of the cell site should be enacted;
a moderate risk level indicating that a second threshold percentage of the multiple wireless devices are unable to comply with the spectrum refarming of the cell site and that the different form of spectrum refarming of the cell site should be considered; and
a low risk level indicating that a third threshold percentage of the multiple wireless devices are unable to comply with the spectrum refarming of the cell site and that the spectrum refarming of the cell site should be enacted.
